(19) United States
(12) Patent Application Publication
(10) Pub. No.: US 2007/0206262 A1
(43) Pub. Date: Sep. 6, 2007

(54) Electrophoretic Display Activation for Multiple Windows

(75) Inventor: Guofu Zhou, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,258

(22) PCT Filed: Mar. 29, 2005
(86) PCT No.: PCT/IB05/51062

§ 371 Date: Sep. 23, 2006

Related U.S. Application Data
(60) Provisional application No. 60/558,070, filed on Mar. 31, 2004.

(51) Int. Cl. G09G 3/34

(52) U.S. Cl. 359/267

(57) ABSTRACT

An electrophoretic display (10) and a system (12) for implementating a method of activating a subwindow (80) of an electrophoretic display (10). The method involves a reception of image information (14) for the subwindow, a determination of an image-holding time (82) for the subwindow, and an addressing of the subwindow of the electrophoretic display based on the received image information and the image-holding time.

This invention relates generally to electrophoretic displays, and more specifically to addressing a subwindow within an array of electrophoretic pixels.

Nonvolatile electrophoretic display media store digital information in the form of viewable text or images. Electrophoretic displays are generally characterized by the movement of polarized or charged particles in an applied electric field, and can be bi-stable with display elements having first and second display states that differ in at least one optical property such as lightness or darkness of a color. In recently developed electrophoretic displays, the display states occur after microencapsulated particles in the electronic ink have been driven to on e state or another by an electronic pulse of a finite duration, and the driven state persists after the activation voltage has been removed.

An exemplary electrophoretic display with microcapsules containing either a cellulosic or gel-like phase and a liquid phase, or containing two or more immiscible fluids are described in “Process for Creating an Encapsulated Electrophoretic Display,” Albert et al., U.S. Pat. No. 6,067,185 issued May 23, 2000 and “Multi-Color Electrophoretic Displays and Materials for Making the Same,” Albert et al., U.S. Pat. No. 6,017,584 issued Jan. 25, 2000.

Electrophoretic displays receive image data and may be addressed by driving an active matrix located on the frontside or backside of the display. The active-matrix displays have intrinsic addressing schemes such as fixed coordinates on a pixel-by-pixel grid to accurately write text and graphics. An exemplary electrophoretic display unit comprises a layer of electrophoretic ink with a transparent common electrode on one side, and a substrate or a backplane having pixel electrodes arranged in rows and columns. The crossing between a row and a column is associated with an image pixel that is formed between a pixel electrode and a portion of the common electrode. The pixel electrode connects to the drain of a transistor, of which the source is electrically coupled to a column electrode and of which the gate is electrically connected to a row electrode. This arrangement of pixel electrodes, transistors, row electrodes and column electrodes jointly forms an active matrix. A row driver supplies a row selection signal via the row electrodes to select a row of pixels and a column driver supplies data signals to the selected row of pixels via the column electrodes and the transistors. The data signals on the column electrodes correspond to data to be displayed, and form, together with the row selection signal, driving signals for driving one or more pixels in the electrophoretic display.

Electrophoretic ink, also referred to as electronic ink or e-ink, is positioned between the transparent common electrode and the pixel electrodes and typically comprises multiple microcapsules having a diameter between about 10 and 50 microns. In one example of a black-and-white display, each microcapsule comprises positively charged white particles and negatively charged black particles suspended in a fluid. When a negative electric field is applied from the pixel electrode to the transparent common electrode, the negatively charged black particles move towards the common electrode and the pixel becomes darker to a viewer. Simultaneously, the positively charged white particles move towards the pixel electrode on the backplane, away from the viewer's sight.

Applying an activation voltage between pixel electrodes and the common electrode for specified periods of time generally creates grayscale in an active-matrix monochromatic electrophoretic display. For a characteristic active-matrix electrophoretic display of current art, pulse-width modulation on a frame-by-frame basis may use, for example, a column driver with three voltage levels: −15 volts, +15 volts and 0 volts.

One method for driving an active-matrix display and controlling gradations of pigment particles is described in “Method and Circuit for Driving Electrophoretic Display and Electronic Device Using Same,” Katase, U.S. Patent App. 2002/0021483 published Feb. 21, 2002. In the method, a reset voltage is applied to each pixel electrode, then an applied voltage for writing to the display is applied to each pixel electrode, and then a common voltage is applied to each pixel electrode so that electric charge accumulated in each capacitor is taken away and a displayed image is held.

Electrophoretic displays have favorable attributes of good brightness and contrast, wide-viewing angles, high stability for two or more optical states, and low power consumption when compared to those of liquid crystal displays (LCDs). Additionally, the average power consumption of electrophoretic displays is much lower than that of LCDs due to the lower required refresh rate.

A description of how driving voltage may be reduced is given in “Method of Producing a Substrate Structure for a Large Size Display Panel and an Apparatus for Producing the Substrate Structure,” U.S. Pat. No. 4,775,549, Ota et al., granted in Oct. 4, 1988. The application of driving voltage is reduced when a pixel equivalent capacitance is kept larger than the capacitance of a nonlinear element or switching element itself. The holding time of voltage applied to a selected pixel may be extended with a parallel capacitance, which may contribute to a low-voltage drive or high-speed response.

One attempt at controlling the brightness of the display and reducing deterioration caused by electrode reaction or electrolysis without drop in contrast is presented in “Migration Time Measuring Method and Electrophoresis Display Device,” Hideyuki, International Patent No. JP9006277 granted in Jan. 10, 1997. A time-control device is used to apply and drive voltage, and a sensor stops the driving voltage when its output corresponds to the saturated value of the brightness previously measured.

A lower refresh rate results from the bi-stability of the electrophoretic material, which can hold an image substantially on the display without supplying any voltage pulse. The voltage pulse is only needed during next image update. Furthermore, no updating or refreshing of a pixel and concomitant driving voltage are needed when the optical state of the pixel does not change during the next image update, resulting still lower power consumption.

However, in current electrophoretic displays, the optical state of a pixel may drift away during an un-powered image-holding period or dwell time, especially in the first 100 seconds following an image update. The brightness decreases as the waiting time increases. This image instability makes it difficult to achieve good image quality for the window of the display, particularly when subwindows are created on the display, such as for dictionary applications where a definition of a word appears in a subwindow when a cursor points to a word in a displayed text.

Generally, the background window is not updated during addressing the subwindow in order to avoid optical flicker and save power. Thus, the pixels outside a subwindow have some remaining image-holding time when the subwindow is addressed. When a drive waveform optimized for a fixed dwell time is used for updating the subwindow, a brightness difference between the subwindow and the background window exists. The difference depends strongly on the image stability of the electronic ink and the image-holding time, which is variable from user to user and dependent on usage mode. The visible and undesirable image retention or ghosting may be evident when multiple subwindows are used or when the display experiences multiple or long dwell times, which are often unavoidable in practical applications.

Therefore, what is needed is an improved addressing method and associated system for multiple display windows of an electrophoretic display that provide the brightness of a newly addressed child window or subwindow to optically match the background of the parent or main window already in an unpowered condition. In addition, a desirable method for driving an electrophoretic display also reduces power consumption and image-update time while offering the required uniformity, resolution and accuracy of the images in the main window and subwindows.

One form of the present invention is a method of activating a subwindow of an electrophoretic display. Image information for a subwindow is received, an image-holding time for the subwindow including electrophoretic pixels in the subwindow is determined, and the subwindow of the electrophoretic display is addressed based on the received image information and the image-holding time.

Another form of the present invention is a system for activating a subwindow of an electrophoretic display, including an electrophoretic pixel array disposed on a backplane, means for receiving image information for the subwindow, means for determining an image-holding time for the subwindow including electrophoretic pixels in the subwindow, and means for addressing the subwindow based on the received image information and the image-holding time.

Another form of the present invention is an electrophoretic display including an electrophoretic pixel array disposed on a backplane, a row driver, a column driver and a controller connected to the row driver and the column driver. The row driver is electrically connected to a set of rows of the electrophoretic pixel array. The column driver is electrically connected to a set of columns of the electrophoretic pixel array. The controller determines an image-holding time for a subwindow of the electrophoretic display and addresses the subwindow based on the received image information and the image-holding time.

The aforementioned forms as well as other forms and features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

Various embodiments of the present invention are illustrated by the accompanying figures, wherein:

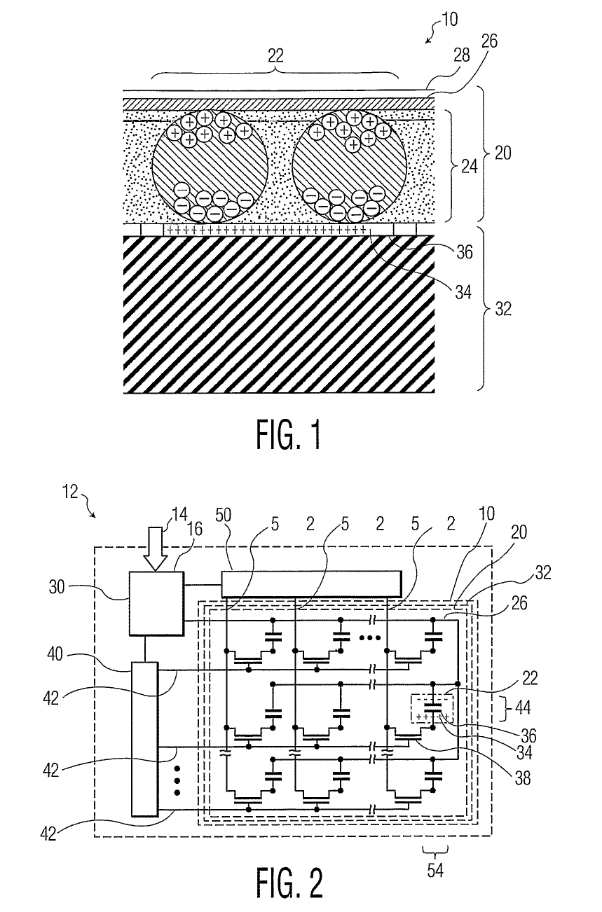

FIG. 1 is an illustrative cross-sectional view of a portion of an electrophoretic display, in accordance with one embodiment of the present invention;

FIG. 2 is a schematic view of a system for activating a subwindow of an electrophoretic display, in accordance with one embodiment of the present invention;

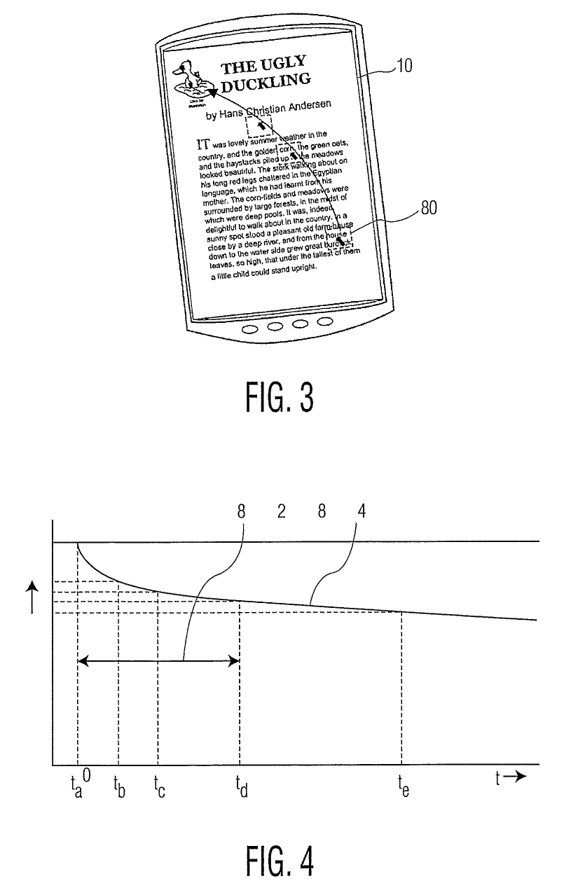

FIG. 3 illustrates a subwindow in an electrophoretic display, in accordance with one embodiment of the present invention;

FIG. 4 shows a graph of white-state brightness for an electrophoretic display as a function of image-holding time, in accordance with one embodiment of the present invention;

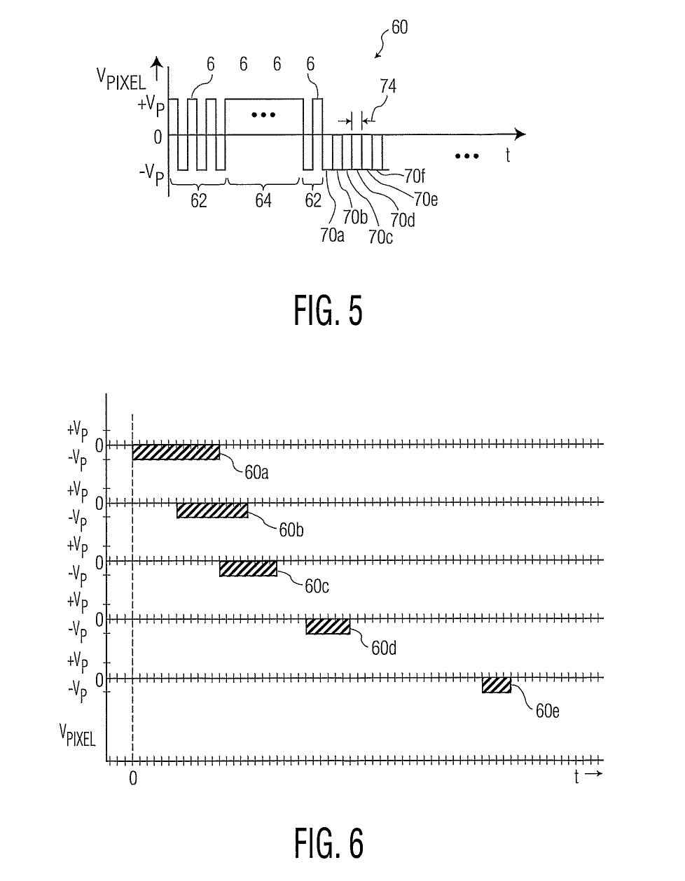

FIG. 5 is a driving waveform for activating a subwindow of an electrophoretic display, in accordance with one embodiment of the present invention;

FIG. 6 is a timing diagram illustrating driving waveforms for a subwindow as a function of image-holding time, in accordance with one embodiment of the present invention;

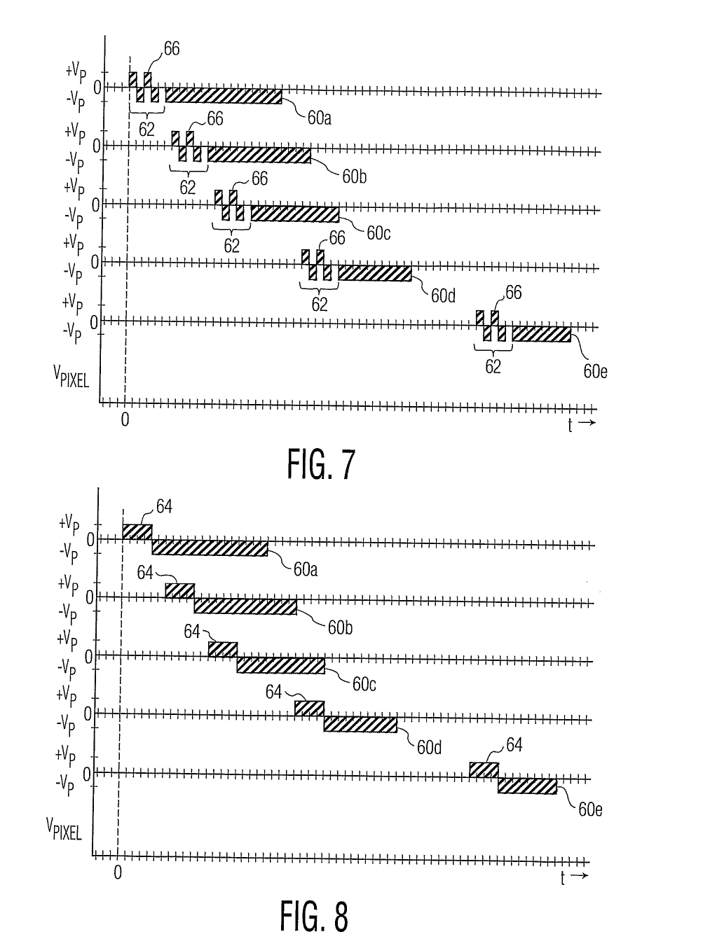

FIG. 7 is a timing diagram illustrating driving waveforms with image-independent shaking pulses as a function of image-holding time, in accordance with one embodiment of the present invention;

FIG. 8 is a timing diagram illustrating driving waveforms with a reset pulse as a function of image-holding time, in accordance with one embodiment of the present invention;

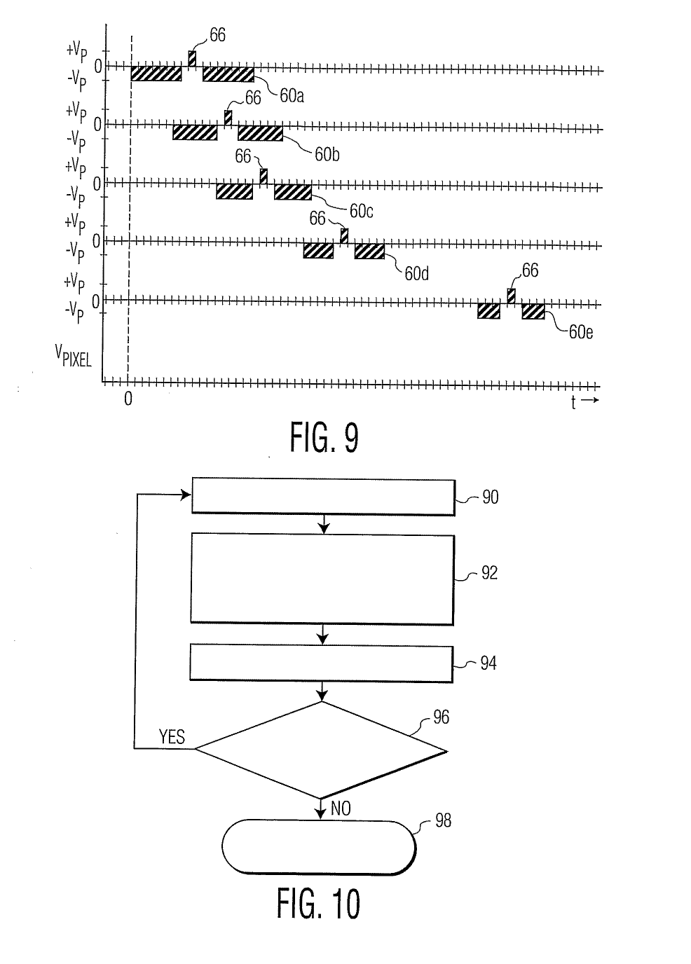

FIG. 9 is a timing diagram illustrating driving waveforms with an image-dependent shaking pulse as a function of image-holding time, in accordance with one embodiment of the present invention; and

FIG. 10 is a flow diagram for a method of activating a subwindow of an electrophoretic display, in accordance with one embodiment of the present invention.

FIG. 1 is an illustrative cross-sectional view of a portion of an electrophoretic display 10, in accordance with one embodiment of the present invention. Electrophoretic display 10 includes an electrophoretic pixel array 20 comprising one or more subwindows within an addressable array of electrophoretic pixels 22.

In an exemplary embodiment, electrophoretic pixel array 20 comprises a layer of electrophoretic ink 24 disposed on a backplane 32. Electrophoretic ink 24 may comprise one of several commercially available electrophoretic inks, commonly referred to as electronic ink or e-ink. Electrophoretic ink 24 comprises, for example, a thin electrophoretic film with millions of tiny microcapsules in which positively charged white particles and negatively charged black particles are suspended in a clear fluid. Other variants are possible, such as positively charged black particles and negatively charged white particles, or colored particles of one polarity and black or white particles of the opposite polarity, or colored particles in a white colored fluid, or particles in a gaseous fluid or colored particles in air.

The encapsulated electrophoretic particles can be rotated or translated by application of an electric field into a desired orientation. The electrophoretic particles reorient or migrate along field lines of the applied electric field and can be switched from one optical state to another based on the direction and intensity of the electric field and the time allowed to switch states. For example, when a positive electric field is applied to the display on a pixel electrode, the white particles move to the top of the microcapsules where they become visible to the user. This makes the surface appear white at the top position or outer surface of the microcapsules. At the same time, the electric field pulls the black particles to the bottom of the microcapsules where they are hidden. When the process is reversed, the black particles appear at the top of the microcapsules, which makes the surface appear dark at the surface of the microcapsules. When the activation voltage is removed, a fixed image remains on the display surface.

Electrophoretic ink 24 may contain an array of colored electrophoretic materials to allow the generation and display of colored images such as an array of magenta, yellow, and cyan electrophoretic materials, or an array of red, green, blue and black electrophoretic materials. Alternatively, electrophoretic display 10 may include an array of colored filters such as red, green and blue positioned above black and white electrophoretic pixels. A matrix of rows and columns allows each electrophoretic pixel 22 to be individually addressed and switched into the desired optical state such as black, white, gray, or another prescribed color. Each electrophoretic pixel 22 may include one or more microcapsules, related in part to the size of the microcapsules and the included area within each pixel element.

A transparent common electrode 26 positioned on one side of electrophoretic ink 24 comprises, for example, a transparent conductive material such as indium tin oxide that al lows topside viewing of electrophoretic display 10. Common electrode 26 does not need to be patterned. Electrophoretic ink 24 and common electrode 26 may be covered with a transparent protective layer 28 such as a thin layer of polyethylene. An adhesive substance may be disposed on the other side of electrophoretic ink 24 to allow attachment to a backplane 32. The layer of electrophoretic ink 24 may be glued, adhered, or otherwise attached to backplane 32. Backplane 32 comprises a plastic, glass, ceramic or metal backing layer having an array of addressable pixel electrodes and supporting electronics. In an alternative embodiment, individual pixel electrodes and the common electrode may be arranged on the same substrate, whereby an in-plane electric field may be generated to move particles in an in-plane direction.

When the layer of electrophoretic ink 24 is attached to backplane 32, individual pixel electrodes 36 on backplane 32 allow a predetermined charge 34 to be placed onto one or more electrophoretic pixels 22. The electric field resulting from charge 34 causes transitions from one optical state to another of electrophoretic ink 24. The electric field generates a force to re-orient and/or displace charged particles in the layer of electrophoretic ink 24, providing a black and white or variable color display from which text, graphics, images, photographs and other image data can be presented. Gray tones or specific colors of electrophoretic ink 24 can be achieved, for example, by controlling the magnitude, level, location and timing of the activation voltage and associated charge 34.

Addressing of electrophoretic ink 24 is accomplished by applying an activation voltage to one or more pixel electrodes 36, placing a predetermined amount of charge 34 thereon and switching electrophoretic ink 24 to the desired optical state. Application and storage of charge 34 onto a pixel electrode 36 allows continued activation of the electrophoretic ink 24 when the activation voltage is removed, even if activation occurs on a slower time scale than the scanning process. The short-term storage effect of charge 34 on the pixel electrodes 36 allows scanning of other rows of pixels while the image continues to form in electrophoretic ink 24. Removal of the applied activation charge 34 quenches or immobilizes electrophoretic ink 24 at the achieved optical state.

For example, electrophoretic ink 24 may be switched from white to black. In another example, an initially black optical state is switched controllably to a gray or white state. In another example, a white optical state is switched to a gray optical state. In yet another example, colored electrophoretic ink 24 switches from one color to another based on the activation voltage and the activation charge 34 applied to pixel electrodes 36. After addressing and switching have been completed, electrophoretic displays incorporating electrophoretic ink 24 continue to be viewable with no additional power consumption.

Electrophoretic pixels 22 are addressable, for example, with a thin-film transistor array on backplane 32 and associated row and column drivers that place predetermined charge 34 onto pixel electrodes 36 of electrophoretic pixel 22 for a prescribed time to reach the desired optical state. Charge 34 is subsequently removed to retain electrophoretic pixel 22 in the acquired optical state. Intermediate values of gray can be obtained by controlling the amount of activation time and the electric field intensity across electrophoretic pixel 22. When the electric field is removed, the particles remain in the acquired optical state, and the image written to electrophoretic display 10 is retained, even with removal of electrical power.

Sections or tiles of electrophoretic display 10 of various sizes may be assembled together or placed side-by-side to form nearly any desired size of electrophoretic display 10 that can be mounted, for example, on panels or other large surfaces. Electrophoretic display 10 may be formed with a size, for example, of a few centimeters on a side to as large as one meter by one meter or larger. Electrophoretic displays 10 with associated driver electronics may be used, for example, in monitors, laptop computers, personal digital assistants (PDAs), mobile telephones, electronic books, electronic newspapers and electronic magazines. With matrix addressing, all or part of the display may be addressed and activated, allowing portions of the display such as subwindows to be directly addressed and updated while other portions of the display retain their previously written images to reduce power consumption and extend battery life for portable applications.

FIG. 2 is a schematic view of a system 12 for activating a window or subwindow such as one or more display windows within an electrophoretic display 10, in accordance with one embodiment of the present invention. The system includes an electrophoretic display 10 having an electrophoretic pixel array 20 containing individually addressable electrophoretic pixels 22 disposed on a display panel or backplane 32, a controller 30, a row driver 40, and a column driver 50. Row driver 40 is electrically connected via a set of row electrodes 42 to a set of rows 44 of electrophoretic pixel array 20. Column driver 50 is electrically connected via a set of column electrodes 52 to a set of columns 54 of electrophoretic pixel array 20. Controller 30 is electrically connected to row driver 40 and column driver 50. Controller 30 sends command signals to row driver 40 and column driver 50 to address electrophoretic pixels 22. A memory may be coupled to or contained within controller 30 to store items such as image data, image-independent driving waveform information, image-dependent driving waveform information, data-frame times, pixel data, subwindow sizes and locations.

Electrophoretic pixels 22 in the display or in a subwindow of the display are activated by applying an activation potential and placing a predetermined charge 34 onto one side of electrophoretic pixel 22 when electrophoretic pixel 22 is addressed by row driver 40 and column driver 50, while common electrode 26 is biased at zero volts or at another suitable potential. Electrophoretic pixel 22 with common electrode 26 on one side and pixel electrode 36 on the other forms a capacitor that can be charged or discharged to the desired level. While charged, electrophoretic pixel 22 will transition from one optical state to another. Additional capacitance may be added in parallel with each electrophoretic pixel 22 to increase charge storage capability. In one example, row driver 40 and column driver 50 cooperate with controller 30 to supply activation voltages with a positive amplitude, a negative amplitude, or zero amplitude to selected electrophoretic pixels 22, thereby transferring positive charge, negative charge, or no charge 34 onto the associated pixel electrodes within the subwindow.

Electrophoretic pixels 22 of electrophoretic pixel array 20 are arranged in a row-column format that allows selection of rows 44 sequentially in turn while image data corresponding to each electrophoretic pixel 22 in the selected row is placed on column electrodes 52. Each electrophoretic pixel 22 in electrophoretic pixel array 20 is electrically connected on one side to common electrode 26 that is referenced, for example, to ground or 0 volts. A predetermined charge 34 may be placed on a pixel electrode 36 on the other side of electrophoretic pixel 22 to drive electrophoretic pixel 22 to the desired optical state. For example, a positive charge 34 placed on electrophoretic pixel 22 causes the pixel to become white, whereas a negative charge 34 placed on electrophoretic pixel 22 causes the pixel to become dark. Discharging or otherwise removal of charge 34 freezes the electrophoretic pixel at the acquired optical state.

An array of active switching elements such as thin-film transistors 38 allows the desired charge 34 to be placed on one side of electrophoretic pixel 22. Row driver 40 is connected via row electrodes 42 to rows 44 of electrophoretic display 10. Each row electrode 42 is connected to the gates of a row of thin-film transistors 38, allowing transistors 38 in the row to be turned on when the row voltage is raised above a turn-on voltage. Row driver 40 sequentially selects row electrodes 42, while column driver 50 provides data signals to column electrodes 52. Column driver 50 is connected to column electrodes 52 of electrophoretic display 10. Each column electrode 52 is connected to the sources of a column of thin-film transistors 38. This arrangement of pixels, transistors 38, row electrodes 42, and column electrodes 52 jointly forms an active matrix. Row driver 40 supplies a selection signal for selecting a row 44 of electrophoretic pixels 22 and column driver 50 supplies data signals to the selected row 44 of electrophoretic pixels 22 via column electrodes 52 and transistors 38.

Preferably, controller 30 first processes incoming image information 14 and generates the data signals and driving waveforms. Mutual synchronization between row driver 40 and column driver 50 takes place via electrical connections with controller 30. Selection signals from row driver 40 select one or more rows 44 of pixel electrodes 36 via transistors 38. Transistors 38 have drain electrodes that are electrically coupled to pixel electrodes 36, gate electrodes that are electrically coupled to the row electrodes 42, and source electrodes that are electrically coupled to column electrodes 52. Data signals present at column electrodes 52 are simultaneously transferred to pixel electrodes 36 coupled to the drain electrodes of turned-on transistors 38. The data signals and the row selection signals together form at least a portion of a driving waveform. The data signals correspond to data to be displayed, and form, together with the selection signals, a driving waveform for driving one or more electrophoretic pixels 22 in the electrophoretic pixel array 20. The composite time for the driving waveform represents an image update period wherein a new image may be written or refreshed.

The magnitude and polarity of charge 34 placed on each electrophoretic pixel 22 depends on the activation voltage applied to pixel electrodes 36. In one example, a negative voltage, zero voltage, or a positive activation voltage may be placed on each column such as −15V, 0V and 15V. As each row 44 is selected, charge 34 may be placed or removed from each pixel electrode 36 in the row based on the column voltage. For example, a negative charge, positive charge or zero charge may be placed on pixel electrode 36 of electrophoretic pixel 22 to switch the optical state accordingly. As the next row 44 is addressed, charges 34 on previously addressed pixels continue to reside on pixel electrodes 36 until updated with a subsequent driving waveform or are otherwise discharged.

Grayscale writing of image data to electrophoretic display 10 may be accomplished by sustaining a predetermined charge 34 on electrophoretic pixel 22 for a series of one or more data frames. Each data frame comprises pixel data and corresponding pixel address information for each row 44 in the display. The time interval to sequentially address all rows 44 in the display once with display information constitutes the data-frame time. To supply image-independent signals to electrophoretic pixels 22 during frames, controller 30 controls column driver 50 so that all electrophoretic pixels 22 in a row 44 receive the image-independent signals simultaneously. This is done row by row, with controller 30 controlling row driver 40 in such a way that rows 44 are selected one after the other, e.g. all transistors 38 in the selected row are brought into a conducting state. To supply image-dependent signals to electrophoretic pixels 22 during a frame, controller 30 controls row driver 40 so that each row 44 is selected in turn, e.g. all transistors 38 in selected row 44 are brought into a conducting state, while controller 30 also controls column driver 50 so that electrophoretic pixels 22 in each selected row 44 receive the image-dependent signals simultaneously via associated transistors 38. Controller 30 provides row driver signals to row driver 40 to select a specific row 44 and provides column driver 50 signals to column driver 50 to place the desired voltage level and corresponding charge 34 onto each electrophoretic pixel 22 in the selected row 44. Controller 30 may provide data frames to selected portions of electrophoretic display 10 such as subwindows, which are described in more detail with FIGS. 3 through 9.

Subsequent frames may contain the same display information or updated display information with additional pixel data. The grayscale level of a specific pixel is determined by the number of consecutive frames with the same content, such as between zero and fifteen adjacent frames with a positive or negative charge 34 applied to pixel electrode 36 after electrophoretic pixel 22 has been reset to a white or black optical state. Each frame has identical data-frame times, resulting in sixteen levels of grayscale resolution per pixel.

Controller 30 processes incoming data, such as image information 14 received via image input 16. Controller 30 detects an arrival of new image information 14 and in response starts the processing of the received image information 14. Processing of image information 14 may include loading new image information 14, comparing the new image information 14 to previous image information stored in a memory coupled to controller 30, accessing memories containing look-up tables of drive waveforms, or interacting with onboard temperature sensors (not shown) to compensate for switching time variations with temperature. Controller 30 may receive image information 14 associated with a subwindow and address electrophoretic display 10 accordingly. Controller 30 detects when processing of image information 14 is ready and electrophoretic pixel array 20 can be addressed.

Controller 30, such as a microprocessor, a microcontroller, a field-programmable gate array (FPGA), or other digital device may receive and execute microcoded instructions to address and write a desired image onto electrophoretic display 10 or a portion thereof. Controller 30 sends row selection signals to row driver 40 and data signals to column driver 50 to activate electrophoretic display 10. Controller 30 may be contained within a personal computer (PC), a laptop computer, a personal digital assistant (PDA), an electronic book, or other digital device and connected to electrophoretic display 10. Alternatively, controller 30 is contained within electrophoretic display 10 on backplane 32.

Controller 30 generates the data signals that are supplied to column driver 50, and in cooperation with row driver 40 generates row selection signals that are supplied to the set of rows 44. Data signals supplied to column driver 50 may include an image-independent portion and an image-dependent portion. Image-independent portions of the driving waveform include signals that are identically applied to some or all of electrophoretic pixels 22 in electrophoretic pixel array 20 such as reset pulses or preconditioning pulses. Image-dependent portions of the driving waveform include image information and may or may not vary between individual electrophoretic pixels 22.

With reference to numbered elements described in further detail in FIGS. 3, 4, and 5, controller 30 determines an image-holding time 82 for a subwindow 80 of electrophoretic display 10 and addresses subwindow 80 of electrophoretic display 10 based on received image information 14 and image-holding time 82 to activate at least one electrophoretic pixel 22 in electrophoretic pixel array 20. Image-holding time 82 is the time interval between updating at least a portion of electrophoretic display 10 and updating subwindow 80. Addressing and updating subwindow 80 comprises writing pixel data onto at least one electrophoretic pixel 22 in subwindow 80. Subwindow 80 is addressed to minimize an optical-state mismatch between the addressed subwindow 80 and another portion of the electrophoretic display outside subwindow 80.

Subwindow 80 of electrophoretic display 10 may be addressed using pulse-width modulation, activation-voltage modulation, or a combination thereof. Pulse-width modulation provides pulses of variable length such as increments of data-frame time to transition electrophoretic pixels 22 to the desired optical state. Modulation of the activation voltage, such as varying the amplitude of the negative or positive activation voltages applied to pixel electrodes 36, affects the driving force for the electrophoretic particles and can be used to achieve additional gray levels, accuracy of gray scale, or matching to background levels within the display.

Controller 30 may generate or select a driving waveform based on image-holding time 82 for subwindow 80. Subwindow 80 of electrophoretic display 10 may be addressed based on the generated or selected driving waveform. The driving waveform may have an image-dependent portion having at least one data frame 70 based on received image information 14 and a current optical state of at least one electrophoretic pixel 22 in subwindow 80. An image-dependent portion of the selected driving waveform may include an image-dependent shaking pulse. The selected driving waveform may include an image-independent portion including one or more shaking pulses prior to or after the image-dependent portion of the driving waveform. One or more reset pulses may be included in an image-independent portion of the selected driving waveform. Controller 30 selects the driving waveform from, for example, a lookup table residing in a memory within or electrically connected to controller 30.

In one embodiment, at least a portion of the selected driving waveform is adjusted based on a scaling factor from, for example, a scaling factor table residing in memory. The scaling factor modifies the time or amplitude of the selected driving waveform to produce the desired optical state in subwindow 80. In another embodiment, controller 30 adjusts a data-frame time 74 of one or more data frames 70 based on image-holding time 82, and subwindow 80 of electrophoretic display 10 is addressed with data frames 70 and adjusted data-frame time 74.

Controller 30 generates a plurality of data frames 70 from received image information 14 and addresses electrophoretic pixel array 20. Image information 14 for subwindow 80 may be received via input 16 of controller 30. Based on image information 14 and other input such as temperature input, controller 30 may adjust data-frame time 74 of data frames 70 to provide increased grayscale resolution and accuracy. Controller 30 determines data frames 70 based on image information 14 during image-dependent portions of the driving waveform.

Controller 30 addresses row driver 40 and column driver 50 based on pixel data and data-frame times 74 of data frames 70 to activate one or more electrophoretic pixels 22 in subwindow 80 within electrophoretic pixel array 20. The contents of data frames 70 may be determined by controller 30 operating and executing associated code. Controller 30 provides data frames 70 including pixel data and data-frame time 74 to electrophoretic pixel array 20. Controller 30 may send serial or parallel pixel data and data-frame times 74 of data frames 70 to row driver 40 and column driver 50 to activate electrophoretic pixels 22 within electrophoretic pixel array 20.

Controller 30 may use one or more data frames 70 to reset electrophoretic display 10 to a predetermined optical state. After an image is written, controller 30 may address and update electrophoretic display 10 with additional data frames 70 in image-dependent or image-independent portions of the driving waveform. When an image has been written, controller 30 may power off or power down electrophoretic display 10 and associated circuitry, while electrophoretic display 10 retains the image written thereon.

Image information 14 may be provided to controller 30 from a parallel or serial connection with a digital computing device, video camera, or other source of display information. With reference to numbered elements described in more detail with FIG. 5, the provided display data may include pixel data and data-frame time 74 with each data frame 70. Alternatively, controller 30 may generate pixel data and data-frame time 74 for each data frame 70 after receiving image information 14 in any suitable display format.

With a high clock speed, controller 30 may adjust data-frame time 74 of data frame 70 to provide increased grayscale resolution and increased accuracy. Electrophoretic display 10 is reset, for example, to a predetermined optical state such as all black, all white, or a pre-specified color or gray level by addressing and switching each electrophoretic pixel 22 in electrophoretic pixel array 20. With subsequently provided image information 14, electrophoretic display 10 may be updated with additional pixel data by addressing and writing onto electrophoretic pixels 22 in electrophoretic display 10. When electrophoretic display 10 is not addressed or a portion or all of system 12 is powered down or powered off, electrophoretic display 10 retains and displays the previously written image.

To account for temperature changes within the display and to mitigate variations in switching time with temperature, a temperature sensor (not shown) may be included on or near backplane 32. Temperature effects may be compensated, for example, by scaling data-frame times 74 in accordance with the current operating temperature of electrophoretic display 10.

FIG. 3 illustrates a subwindow 80 in an electrophoretic display 10, in accordance with one embodiment of the present invention. Subwindow 80 comprises a portion of electrophoretic display 10, as might be used with a personal digital assistant (PDA), a mobile telephone, an electronic dictionary or an electronic book.

An exemplary subwindow 80 comprises a square or rectangular region including and surrounding an object such as a cursor, a selection arrow, a mouse icon or a sized application window. As subwindow 80 is moved or resized, electrophoretic display 10 is locally updated in subwindow 80 along with newly exposed portions of the background or other windows. Multiple subwindows 80 may be imaged with electrophoretic display 10, such as with menu bars, selection icons, or separate subwindows 80 for one or more applications being displayed simultaneously on electrophoretic display 10.

FIG. 4 shows a graph of white-state brightness for an electrophoretic display as a function of un-powered image-holding time, in accordance with one embodiment of the present invention. A characteristic brightness curve 84 for an electrophoretic ink shows an initial brightness at time tₐ representing a white optical state. When the electrophoretic ink is activated, the brightness is at its highest level. When power is removed, the image continues to be displayed, although the intensity or brightness decays over time. As time progresses, the brightness decreases along brightness curve 84. At time t_{b}, the brightness has decreased towards a gray level. As time passes without refreshing through time t_{c}, t_{d} and tₑ, the brightness continues to decrease until the display is refreshed or updated. A high frequency of refreshing or updating of a portion or all of the electrophoretic display results in consistently high brightness and consistent gray levels. However, for low power applications such as portable displays, infrequent display updates and the activation and updating of only selected portions can appreciably reduce power consumption requirements, a desirable attribute for extending battery life.

When a portion of the display is updated while other portions have decayed, the optical states of the updated and non-updated portions may be mismatched and visible to the viewer. Optical state mismatch may be minimized by activating pixels in subwindow of the display to optically match the brightness of surrounding pixels. One way of achieving this is to determine the amount of time since the previous display update, and transition the pixels in the subwindow to an optical state that matches the brightness of surrounding pixels. Following along brightness curve 84, when an amount of image-holding time 82 corresponds to, for example, time t_{d}, then the optical state written to pixels in the subwindow are adjusted to match the decayed brightness, thereby avoiding ghosting, remnant images, and other optical affects. Further improvements may be achieved by matching the decay rate as well as the time-dependent brightness.

FIG. 5 shows one example of a driving waveform for activating a subwindow in an electrophoretic display, in accordance with one embodiment of the present invention. FIG. 5, which is described with reference to numbered elements of FIGS. 1 through 4, illustrates a driving waveform 60 for activating electrophoretic display 10 with data frames 70 in an image-dependent portion of driving waveform 60. Driving waveform 60 represents voltages across electrophoretic pixel 22 in electrophoretic display 10 as a function of time t. Driving waveform 60 is applied to electrophoretic pixels 22 using row selection signals from row driver 40 and data signals supplied via column driver 50. Driving waveform 60 comprises, for example, a column driving signal and a row selection signal for providing preconditioning or shaking pulses, one or more reset signals, and data signals associated with each optical state and transitions thereto. Data frames 70 are applied in an image-dependent portion of driving waveform 60 represented by data frames 70a, 70b, 70c, 70d, 70e and 70f. Data frames 70 may also be introduced into image-independent portions of driving waveform 60, such as a preconditioning portion 62 and a reset portion 64.

Driving waveform 60 comprises multiple data frames 70, including an image-dependent portion with a plurality of data frames 70. Driving waveform 60 also includes an image-independent portion comprising, for example, one or more preconditioning portions 62, reset portion 64, or a combination thereof. The timing for image-dependent data frames 70, preconditioning portions 62, and reset portions 64 is intended to be illustrative and is not necessarily drawn to scale. Data-frame time 74 is the time interval required to address pixels of all rows 44 once by driving each row one after the other and by driving all columns 54 simultaneously once per row. During each data frame 70, image-dependent or image-independent data is supplied to one or more electrophoretic pixels 22 in the array. Driving waveform 60 comprises, for example, a series of shaking pulses in preconditioning portion 62 followed by a series of reset pulses in reset portion 64, another set of shaking pulses in another preconditioning portion 62, and a combination of driving pulses to drive electrophoretic pixel 22 into the desired optical state.

For example, an electrophoretic display 10 with four gray levels may have sixteen different driving waveforms 60 stored in a lookup table in a memory that is electrically connected to or part of controller 30. From an initial black state, four different driving waveforms 60 allow the initially black pixel to be optically switched to black, dark gray, light gray, or white. From an initially dark-gray state, four different driving waveforms 60 allow the initially dark-gray pixel to be optically switched to black, dark gray, light gray, or white. Additional driving waveforms 60 allow a light gray or a white pixel to be switched to any of the four gray levels. In response to image information 14 received via image input 16, controller 30 may select the corresponding driving waveform 60 from a lookup table for one or more electrophoretic pixels 22, and supply the corresponding row selection signals and column data signals via row driver 40 and column drivers 50 to corresponding transistors 38 connected to corresponding pixel electrodes 36. To match the optical states of background pixels, the driving waveforms 60 for driving electrophoretic pixels 22 within subwindow 80 may be adapted.

To reduce the dependency of the optical response of electrophoretic display 10 on the image history of the pixels, preconditioning signals may be applied to electrophoretic pixels 22 prior to the application of reset signals or image-dependent signals. Preconditioning allows electrophoretic pixels 22 to switch faster with higher uniformity of transitions between one optical state and another. During preconditioning portions 62 of driving waveform 60, alternating pulses of positive and negative voltage, sometimes referred to as shaking pulses 66, are applied to one or more electrophoretic pixels 22 of the display in preparation for subsequent optical state transitions. For example, a set of alternating positive and negative voltages is applied sequentially to the pixels. These preconditioning signals may comprise applying alternating voltage levels to electrophoretic pixels that are sufficient to release the electrophoretic particles from a static state at one or both electrodes, yet either sum to zero or are too short to significantly alter the current positions of the electrophoretic particles or the optical state of the pixel. Because of the reduced dependency on the image history, the optical response of pixels to new image data are substantially independent of whether the pixel was previously black, white or gray. The application of the preconditioning signals reduces the dependency and allows a shorter switching time.

For example, during the initial portion of driving waveform 60, a first set of frames comprising the pulses of the preconditioning signals are supplied to the pixels, each pulse having a duration of one frame period. First shaking pulse 66 has a positive amplitude, second shaking pulse 66 has a negative amplitude, and third shaking pulse 66 has a positive amplitude with additional pulses in an alternating sequence until preconditioning portion 62 is completed. As long as the duration of these pulses is relatively short or the pulses are applied in rapidly changing positive and negative levels, the pulses do not change the gray value displayed by the pixel. A shaking pulse is generally defined as a voltage pulse representing energy sufficient to release the electrophoretic particles from the current state at one or both electrodes though insufficient to bring the particles from one of the extreme positions near the electrodes to the other extreme position near the other electrode.

During reset portion 64 of driving waveform 60, electrophoretic display 10 is reset to a predetermined optical state, such as an all-black state, an all-white state, a gray-scale state, or a combination thereof. The reset pulses within reset portion 64 precede the image-dependent pulses to improve the optical response of electrophoretic display 10 by defining a fixed starting point such as black, white, or an intermediate gray level for the image-dependent pulses. For example, the starting point is selected based on previous image information or the closest gray level to new image data. A set of frames comprising one or more frame periods is supplied including pixel data associated with the desired optical state. The activation voltage and activation charge 34 may be applied for a time longer than is required to fully switch the addressed portions of electrophoretic display 10 to the initialized optical state, and then may be removed. Alternatively, electrophoretic display 10 may be reset with a positive or a negative voltage applied to common electrode 26 while pixel electrodes 36 are maintained at a low voltage or ground potential. To set electrophoretic pixels 22 at the desired optical state, adapted data frames 70 may be used.

After reset portion 64 of driving waveform 60 has been applied, electrophoretic pixels 22 appear in the predetermined optical state to the viewer. An additional preconditioning portion 62 may be applied to one or more electrophoretic pixels 22 after application of reset portion 64 in preparation for writing or updating an image to the display. Prior to addressing the display with image-dependent data, an additional preconditioning portion 62 may be added after reset portion 64 to prepare the pixels for receiving image-dependent frame data.

During the image-dependent portion of driving waveform 60, a set of data frames 70 comprising one or more frame times or periods is generated and supplied. The image-dependent signals have duration, for example, of zero, one, two, through fifteen frame periods or more with non-zero data signals corresponding to sixteen or more grayscale levels. When starting with a pixel in a black optical state, an image-dependent signal having a null pixel data or equivalently a duration of zero frame periods corresponds with the pixel continuing to display black. In the case of a pixel displaying a specific gray level, the gray level remains unchanged when being driven with a pulse having a duration of zero frame periods, or with a sequence of pulses having zero amplitude. An image-dependent signal having a duration of fifteen frame periods comprises fifteen subsequent pulses and corresponds to, for example, the pixel transitioning to and displaying white. An image-dependent signal having a duration of one to fourteen frame periods comprises one to fourteen subsequent pulses and corresponds to, for example, the pixel displaying one of a limited number of gray values between black and white.

Electrophoretic display 10 is updated with image information converted and applied as pixel data to each pixel in the display on a row-by-row basis with one or more data frames 70, represented as data frames 70a, 70b, 70c, 70d, 70e and 70f, each having pixel data. In the example shown, data-frame times of data frames 70a through 70f are constant. Data-frame times 74 associated with data frames 70 may be adjusted to provide increased grayscale resolution and accuracy. Controller 30 may adjust data-frame time 74 of any frame in driving waveform 60 to improve the grayscale resolution or to reach a specific gray level, such as by delaying the start of a frame period and thereby extending the preceding frame time, by adjusting the number of clock cycles between the start of a row selection signal and the start of the next row selection signal, or by adjusting the overall system clock speed as applied to row driver 40.

Electrophoretic display 10 may be updated with additional pixel data supplied with subsequently applied driving waveforms 60. For example, to update electrophoretic pixels 22 in electrophoretic display 10, a row selection signal is applied sequentially to each row 44 of the display, while pixel data for electrophoretic pixels 22 in each row is applied to columns 54 connected to pixel electrodes 36. Positive charge, negative charge, or no charge is transferred onto pixel electrodes 36 in accordance with the frame data, and electrophoretic pixels 22 respond accordingly with a darker state, a lighter state, or no change.

To activate electrophoretic display 10, controller 30 may execute a computer program to convert image information into a series of driving waveforms 60 and address the display accordingly. The computer program includes computer program code to receive image information 14 for subwindow 80, to determine an image-holding time 82 for subwindow 80, and to address subwindow 80 of electrophoretic display 10 based on the received image information 14 and image-holding time 82. The computer program may also contain computer program code to select a driving waveform 60 based on image-holding time 82 for subwindow 80, and to address subwindow 80 of electrophoretic display 10 based on the selected driving waveform 60. The computer program may contain computer program code to adjust selected driving waveform 60 based on a scaling factor from a scaling factor table, or to adjust a data-frame time 74 of at least one data frame 70 based on image-holding time 82, and addressing subwindow 80 of electrophoretic display 10 with data frames 70 and adjusted data-frame time 74.

FIG. 6 is a timing diagram illustrating driving waveforms 60 for a subwindow as a function of image-holding time 82, in accordance with one embodiment of the present invention. Driving waveforms 60, represented by driving waveforms 60a, 60b, 60c, 60d and 60e, may be selected based on image-holding time 82 for subwindow 80 as described with respect to FIG. 4. In the cases shown, a black pixel transitions to a white pixel to match a white background. Driving waveform 60a is selected for the case where one or more pixels in subwindow 80 are updated coincidently with or immediately following a complete screen refresh or display update to match the b rightness level of the white background. As time increases after the screen update, driving waveform 60b may be used to transition a black pixel to a slightly darker white pixel to match the slightly less-than-white background. As may be observed by close inspection, the number of frames for the negative voltage pulses is reduced from driving waveform 60a so that a slightly less white state is obtained. With a further increase in time after the screen update, driving waveform 60c may be used to transition a black pixel to an even slightly darker white pixel that matches the slightly more decayed and darker white background. The number of frames for the negative voltage pulses is reduced from the driving waveform 60a and 60b. With a further increase in time after the screen update, driving waveforms 60d and 60e may be used to transition a black pixel to an optical state that matches the decayed white background.

FIG. 7 is a timing diagram illustrating driving waveforms 60 with image-independent preconditioning or shaking pulses 66 in a preconditioning portion 62 as a function of image-holding time, in accordance with one embodiment of the present invention. Preconditioning portion 62 aids in preconditioning the electrophoretic ink for rapid and accurate transitions to the desired optical state and may be positioned prior to activation voltages of driving waveforms 60a, 60b, 60c, 60d and 60e, as discussed in reference to FIG. 6.

FIG. 8 is a timing diagram illustrating driving waveforms 60 with reset pulses of reset portion 64 as a function of image-holding time, in accordance with one embodiment of the present invention. Reset pulses of reset portion 64 aid in resetting one or more electrophoretic pixels to a prescribed initial state such as an all-white or all-black optical state prior to application of driving waveforms 60a, 60b, 60c, 60d and 60e, as discussed in reference to FIG. 6.

FIG. 9 is a timing diagram illustrating driving waveforms 60 with one or more image-dependent shaking pulses 66 as a function of image-holding time, in accordance with one embodiment of the present invention. Image-dependent shaking pulses 66 may be positioned symmetrically or asymmetrically within driving waveforms 60 to slow or otherwise mitigate the decay affect, allowing both the brightness and decay rate to be matched with the background for driving waveforms 60a, 60b, 60c, 60d and 60e, as discussed in reference to FIG. 6.

FIG. 10 is a flow diagram for a method of activating one or more subwindows of an electrophoretic display, in accordance with one embodiment of the present invention. The activation method includes exemplary steps to activate a subwindow of an electrophoretic display.

Image information is received, as seen at block 90. Image data may be received from a memory device such as a memory stick, or an uplink from a PC, laptop computer or PDA that is optionally connected to a controller electrically coupled to the electrophoretic display. Image information may be received via a wired or wireless link from any suitable source such as a video feed, an image server, or a stored file. The controller may be connected to a communications network such as a local area network (LAN), a wide-area network (WAN), or the Internet to receive and send information and to transfer images onto the electrophoretic display. The image information may be provided in real time as the image is written to the electrophoretic display, or stored within memory until written. When image information is received, the image data may be processed to generate and provide a plurality of data frames including pixel data and data-frame times to address and activate a subwindow of the electrophoretic display.

An image-holding time for the subwindow is determined, as seen at block 92. Determining the image-holding time comprises determining the time interval between updating at least a portion of the electrophoretic display and addressing the subwindow of the electrophoretic display.

To update a subwindow, a driving waveform may be generated or selected based on the image-holding time for the subwindow. The driving waveform may be selected from, for example, a lookup table stored in memory.

In one embodiment, the driving waveform is selected based on the image-holding time for the subwindow, and the subwindow is addressed based on the selected driving waveform. The selected driving waveform may include an image-dependent portion having at least one data frame based on the received image information and a current optical state of at least one electrophoretic pixel in the subwindow. The image-dependent portion of the selected driving waveform may include one or more image-dependent shaking pulses. An image-independent portion of the selected driving waveform may include one or more image-independent shaking pulses. An image-independent portion of the selected driving waveform may include one or more reset pulses.

In another embodiment, the driving waveform at a reference image-holding time (such as at time tₐ in FIG. 4) is selected for the subwindow, and the selected driving waveform is adjusted based on a scaling factor for the subwindow image-holding time from, for example, a scaling factor table.

In another embodiment, a data-frame time of at least one data frame is adjusted based on the image-holding time, and the subwindow is addressed with the data frames and the adjusted data-frame time to activate the subwindow. The data-frame time of one or more data frames may be adjusted to provide increased grayscale resolution, increased accuracy, and matching of optical states within the subwindow to portions of the electrophoretic display external to the subwindow. Alternatively, the activation-voltage amplitude of one or more data frames may be adjusted to provide the desired levels and optical matching.

In another embodiment, the number of data frames in the selected driving waveform is adjusted based on the image-holding time as a form of pulse-width modulation, and the subwindow is addressed with the adjusted waveform to activate the subwindow. In another embodiment, the activation-voltage amplitude of the selected driving waveform is adjusted based on the image-holding time as a form of activation-voltage modulation, and the subwindow is addressed with the adjusted waveform to activate the subwindow.

The subwindow of the electrophoretic display is addressed, as seen at block 94. The subwindow is addressed based on the received image information and the image-holding time. Addressing the subwindow of the electrophoretic display comprises, for example, writing pixel data onto at least one electrophoretic pixel in the subwindow. The subwindow of the electrophoretic display is addressed to minimize an optical-state mismatch between the addressed subwindow and another portion of the electrophoretic display such as the background, the main window, or another subwindow.

Data frames may include null pixel data when no change to the optical state of the associated pixels is desired. Alternatively, pixel data corresponding to positive or negative activation voltages and positive or negative charge on the pixel electrodes may be used to activate the electrophoretic ink within the subwindow to provide increased grayscale resolution, accuracy, and grayscale matching.

The subwindow of the electrophoretic display may be addressed using pulse-width modulation, activation-voltage modulation, or a combination thereof.

When the electrophoretic display is addressed and an image is transferred to the electrophoretic display, an activation voltage is applied to one or more electrophoretic pixels and a predetermined charge is placed on corresponding pixel electrodes based on the pixel data and the data-frame times. The activation voltage is selected to switch selected portions of the electrophoretic display from the reset state or a previous optical state to the desired optical state. As charge is placed on pixel electrodes, the electrophoretic ink is activated and switches to the desired optical state. When the predetermined charge is placed across the pixels of the electrophoretic display, the electrophoretic ink continues to transition to an intended display state as long as the activation voltage is applied or the applied charge is retained on a pixel electrode. Based on the number, length and content of data frames, the electrophoretic ink is provided sufficient time to switch optical states in the designated pixels. The desired optical state for the electrophoretic display can be locked in or frozen by removal of the activation charge and the activation voltage from pixels in the display.

Driving waveforms containing one or more data frames may be generated or selectively extracted, for example, from a lookup table stored in memory and provided to the electrophoretic display. The driving waveforms may contain image-dependent data frames selected to transition the electrophoretic pixels to the desired optical state and compensated for the image-holding time. The driving waveforms may contain image-independent data frames including one or more shaking pulses or one or more reset pulses.

The subwindow of the electrophoretic display may be preconditioned and/or reset to a predetermined optical state. Before the subwindow is addressed, electrophoretic ink of the display material may be reset to a well-defined state. The electrophoretic ink can be forced into an initialized or reset optical state through an applied electric field with, for example, the sustained application of relatively high activation voltage applied to electrophoretic pixels within the subwindow via the pixel electrodes. When the electrophoretic display is reset, one or more pixels in the subwindow are reset to the predetermined optical state, such as an all-white, all-black, gray, or colored optical state, depending on the type of electrophoretic ink and the applied activation voltage. From this reset optical state, the electrophoretic ink can be adjusted in one common direction or another based on the driving forces applied to the electrophoretic pixels. Alternatively, the subwindow of the electrophoretic display may be reset with a pattern similar to the image to be written, so that only a fraction of the total switching time for the electrophoretic ink is needed to write the image in the subwindow with the desired grayscale resolution and accuracy. Similar to the data-dependent portion of the driving waveform, the electrophoretic display may be reset with a plurality of image-independent data frames including pixel data and data-frame times.

Prior to, in conjunction with or as an alternative to resetting the display, the subwindow of the electrophoretic display may be preconditioned with the application of one or more shaking or preconditioning pulses. Shaking pulses are applied to the electrophoretic pixels in the subwindow to precondition the electrophoretic pixels for receiving pixel data or for switching to a reset state. The electrophoretic ink is preconditioned, for example, with the application of an alternating activation voltage applied to pixel electrodes in the subwindow of the display. After resetting the subwindow and prior to writing an image, the subwindow may be preconditioned once again with the application of additional shaking pulses.

After the desired image has been written to the electrophoretic display, the image may be viewed. Further refreshing or writing of new images may occur as desired within, for example, a portion of a second, minutes, hours, days, weeks or even months after writing previous images.

The electrophoretic display may be refreshed or updated with additional image information and pixel data, as seen at block 96. New image data may be received, and the electrophoretic display updated accordingly by repeating the above steps of blocks 90 through 94. Alternatively, the display may require refreshing with stored image information, and previous image data may be re-sent to the display.

When no refreshing or updating of the image is required, circuitry may be powered down or turned off, the electrophoretic display may be powered off or otherwise placed in a power-down mode, as seen at block 98. When powered off or powered down, the electrophoretic display retains the image previously written to the display, unless written over with a black, white or other predetermined screen image.

While the embodiments of the invention disclosed herein are presently considered to be preferred, various changes and modifications can be made without departing from the spirit and scope of the invention. The polarity of preconditioning and reset voltages, the data-frame times, the length of the driving waveform and the order of the portions included thereof, the number of gray levels, the size and number of pixel elements, the color of electrophoretic ink, and the thickness of the various layers have been chosen to be illustrative and instructive. The activation voltages, timing, color of the electrophoretic ink, scale and relative thickness of the included layers, pixel size, array size, driving waveforms and other signals and quantities may vary appreciably from t hat which is shown without departing from the spirit and scope of the claimed invention. This invention is applicable to other bi-stable displays. The scope of the invention is indicated in the appended claims, and all changes that come within the meaning and range of equivalents are intended to be embraced therein.

1. A method of activating a subwindow (80) of an electrophoretic display (10), the method comprising:
receiving image information (14) for the subwindow;
determining an image-holding time (82) for the subwindow; and
addressing the subwindow of the electrophoretic display based on the received image information and the image-holding time.

2. The method of claim 1, wherein determining the image-holding time includes determining the time interval between updating at least a portion of the electrophoretic display and addressing the subwindow of the electrophoretic display.

3. The method of claim 1, wherein addressing the subwindow of the electrophoretic display includes writing pixel data onto at least one electrophoretic pixel (22) in the subwindow.

4. The method of claim 1, wherein the subwindow of the electrophoretic display is addressed to minimize an optical-state mismatch between the addressed subwindow and another portion of the electrophoretic display.

5. The method of claim 1, further comprising:
selecting a driving waveform (60) based on the image-holding time for the subwindow; and
addressing the subwindow of the electrophoretic display based on the selected driving waveform.

6. The method of claim 5, wherein the selected driving waveform includes an image-dependent portion having at least one data frame (70) based on the received image information and a current optical state of at least one electrophoretic pixel in the subwindow.

7. The method of claim 5, wherein the image-dependent portion of the selected driving waveform includes an image-dependent shaking pulse (66).

8. The method of claim 5, wherein the selected driving waveform includes an image-independent portion including at least one shaking pulse (66).

9. The method of claim 5, wherein the selected driving waveform includes an image-independent portion including a reset pulse.

10. The method of claim 5, wherein the driving waveform is selected from a lookup table.

11. The method of claim 5, further comprising:
adjusting the selected driving waveform based on a scaling factor from a scaling factor table.

12. The method of claim 5, further comprising:
adjusting a number of data frames in the selected driving waveform based on the image-holding time; and
addressing the subwindow of the electrophoretic display with the adjusted driving waveform to activate the subwindow.

13. The method of claim 5, further comprising:
adjusting an activation voltage amplitude of the selected driving waveform based on the image-holding time; and
addressing the subwindow of the electrophoretic display with the adjusted driving waveform to activate the subwindow.

14. The method of claim 1, further comprising:
adjusting a data-frame time (74) of at least one data frame based on the image-holding time; and
addressing the subwindow of the electrophoretic display with the at least one data frame and the adjusted data-frame time.

15. A system (12) for activating a subwindow (80) of an electrophoretic display (10), the system comprising:
an electrophoretic pixel array (20) disposed on a backplane (32);
means for receiving image information (14) for the subwindow;
means for determining an image-holding time (82) for the subwindow; and
means for addressing the subwindow of the electrophoretic display based on the received image information and the image-holding time.

16. The system of claim 15, further comprising:
means for selecting a driving waveform (60) based on the image-holding time for the subwindow; and
means for addressing the subwindow of the electrophoretic display based on the selected driving waveform.

17. The system of claim 16, further comprising:
means for adjusting the selected driving waveform based on a scaling factor from a scaling factor table.

18. The system of claim 15, further comprising:
means for adjusting a data-frame time (74) of at least one data frame (70) based on the image-holding time; and
means for addressing the subwindow of the electrophoretic display with the at least one data frame and the adjusted data-frame time.

19. An electrophoretic display (10), comprising:
an electrophoretic pixel array (20) disposed on a backplane (32);
a row driver (40) electrically connected to a set of rows (44) of the electrophoretic pixel array;
a column driver (50) electrically connected to a set of columns (54) of the electrophoretic pixel array; and
a controller (30) electrically connected to the row driver and the column driver;
wherein the controller determines an image-holding time (82) for a subwindow (80) of the electrophoretic display; and
wherein the controller addresses the subwindow of the electrophoretic display based on the received image information and the image-holding time to activate at least one electrophoretic pixel (22) in the electrophoretic pixel array.

20. The electrophoretic display of claim 19, wherein the controller receives image information (14) for the subwindow.
